(19) United States
(12) Patent Application Publication
(10) Pub. No.: US 2005/0168592 A1
(43) Pub. Date: Aug. 4, 2005

(54) Apparatus and method for capturing an informal image with a digital camera

(76) Inventor: Robert G. DeMoor, Sugar Land, TX (US)

Correspondence Address: TEXAS INSTRUMENTS INCORPORATED, P O BOX 655474, M/S 3999, DALLAS, TX, 75265, US

(21) Appl. No.: 10/768,614

(22) Filed: Jan. 30, 2004

(51) Int. Cl. H04N 5/335; G03B 41/00; G04F 8/00; G04F 10/00; H04N 3/14

(52) U.S. Cl. 348/222.1; 396/323; 348/311; 368/108

(57) ABSTRACT

In a digital camera in a first embodiment, components are added such that when the user operates the switch to acquire an image, the camera provides the external sounds and activity simulating the acquisition of an image, but without actually acquiring a image. The activation of the switch initiates operation of a timing unit. The actual image acquisition is acquired without user input after a preselected time determined by the timing unit. In the second embodiment, activation of a timing unit by switch causes the digital camera to acquire images periodically. The images are transferred to a processing unit where a pattern recognition program examines the acquired image for a preselected feature, such as smile on a face of a subject. When the preselected feature is identified, the digital camera stores the image providing the preselected feature. This invention can be used in the photographing of children.

### FIELD OF THE INVENTION

This invention relates to digital cameras and, more particularly, to apparatus for capturing an improved image by a digital camera.

### BACKGROUND OF THE INVENTION

The use of digital cameras has been increasing in the past few years. The conveniences of reviewing an image before committing the image to storage as well as the ability to download images over the internet are a few of the features that are particularly attractive to camera operators.

Referring to FIG. 1, a diagram illustrating the components of a digital camera 10, according to the prior art, is shown. The operation of the digital camera can be understood as follows. A user activates switch 11 in order to acquire a photographic image. The switch 11 applies an activation signal to processing unit 12. For a relatively simple digital camera, the processing unit 12 will provide the proper conditions for photo-sensitive region 15 to acquire an image, will activate the flash assembly 13, and will activate the shutter assembly 14. Activation of the shutter assembly 14 will cause an optical image to be applied to the photo-sensitive region 15. After the image has been applied to the photo-sensitive region 15, the image is converted into logic signals and is processed by the processing unit 12. In more complex systems, the external illumination level can be monitored and the processing unit 12 can control the time in which the photo sensitive region is illuminated by the subject.

However, some of the problems of attempting to capture a suitable image have remained. One particularly frustrating situation is the photographing of children. The experience of many amateur photographers is that, despite coaxing and/or a variety of artifices, the desired smile frequently appears only after the picture has been taken. Furthermore, child subjects in particular frequently display a grimace while being photographed, the grimace typically being relatively unattractive. Once the picture has been taken, the subject children presumably relax and only then provide a pleasing facial expression to the frustration of the camera operator.

A need has therefore been felt for apparatus and an associated method having the feature that a desired image can be acquired in situations in which the subject has trouble in relaxing. It would be a further feature of the apparatus and associated method to provide a delayed image acquisition of the subject after a simulated image acquisition of the subject. It would be still another feature of the apparatus and associated method to process a sequence of acquired images to search for the presence of a predetermined feature and to discard the acquired images until an image with the predetermined feature is identified.

### SUMMARY OF THE INVENTION

The aforementioned and other features are accomplished, according to the present invention, by providing, in one mode of operation, a timer in a digital camera. The digital camera provides a simulated exposure, including shutter and other camera noises and providing a flash. The simulated exposure activates the timing mechanism. After a preselected length of time, the timer activates the digital camera to acquire an image. The preselected period of time is selected to provide time for the subject to relax having assumed that the simulated exposure was the actual exposure. According to a second embodiment of the present invention, the digital camera includes a program for general facial image recognition. In particular, the facial image recognition program permits the recognition of preselected feature (e.g. smile) on a facial image. In this embodiment, the activation of the timer results in the image being periodically displayed on the photo-sensitive region and periodically transferred to the processing unit. When the processing unit, operating under control of the image recognition program, identifies the preselected feature, the digital camera stores the image.

Other features and advantages of the present invention will be more clearly understood upon reading of the following description and the accompanying drawings and claims.

### BRIEF DESCRIPTION OF THE DRAWINGS

FIG. 1 is diagram of a digital camera according to the prior art.

FIG. 2 is diagram of a digital camera according to a first embodiment of the present invention.

FIG. 3 is a diagram of a digital camera according to a second embodiment of the present invention.

### DESCRIPTION OF THE PREFERRED EMBODIMENT

1. Detailed Description of the Drawings

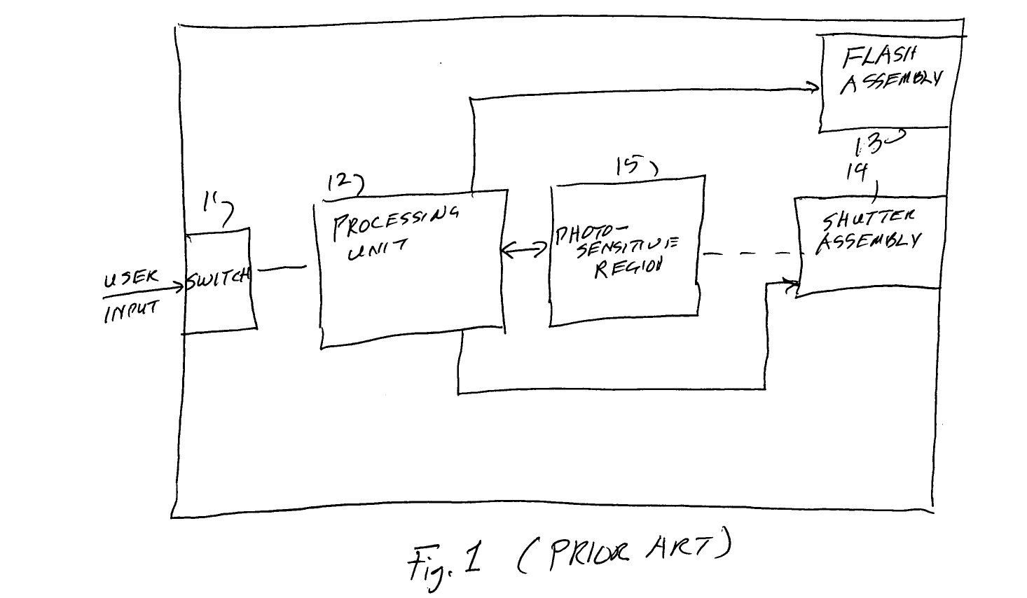

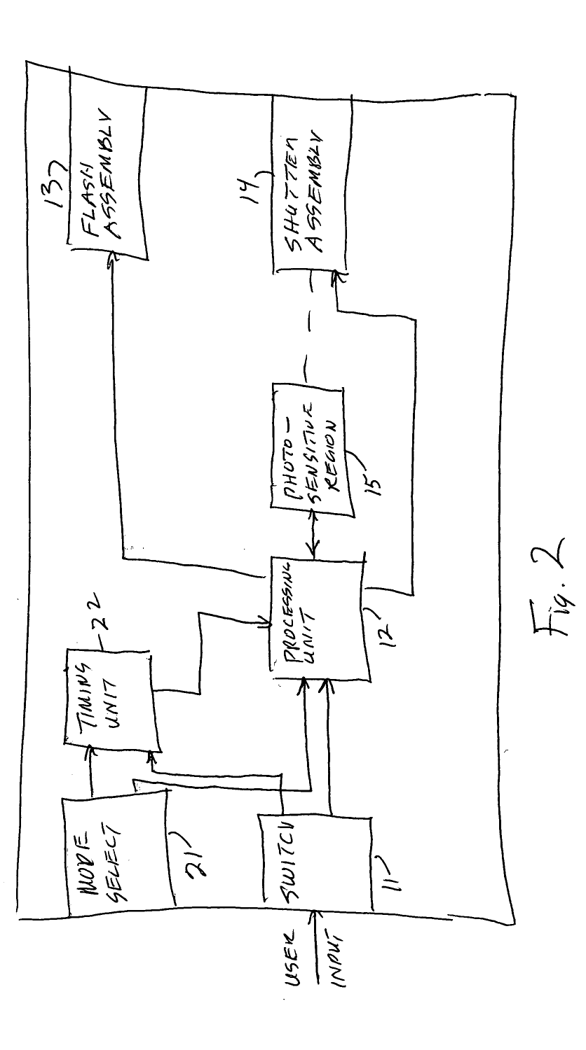

Referring to FIG. 2, a diagram of the digital camera according to a first embodiment of the present invention is shown. Added to the components shown in FIG. 1 is a mode select switch accessible to the user. The mode select switch 21, when activated, applies a signal to the timing unit 22. The mode select switch 21 also applies a signal to the processing unit such that, when the switch 11 is activated, the components of the digital camera respond by imitating the acquisition of an image. However, the actual image is acquired after the preselected time in response to a signal from the timing unit to the processing unit 12.

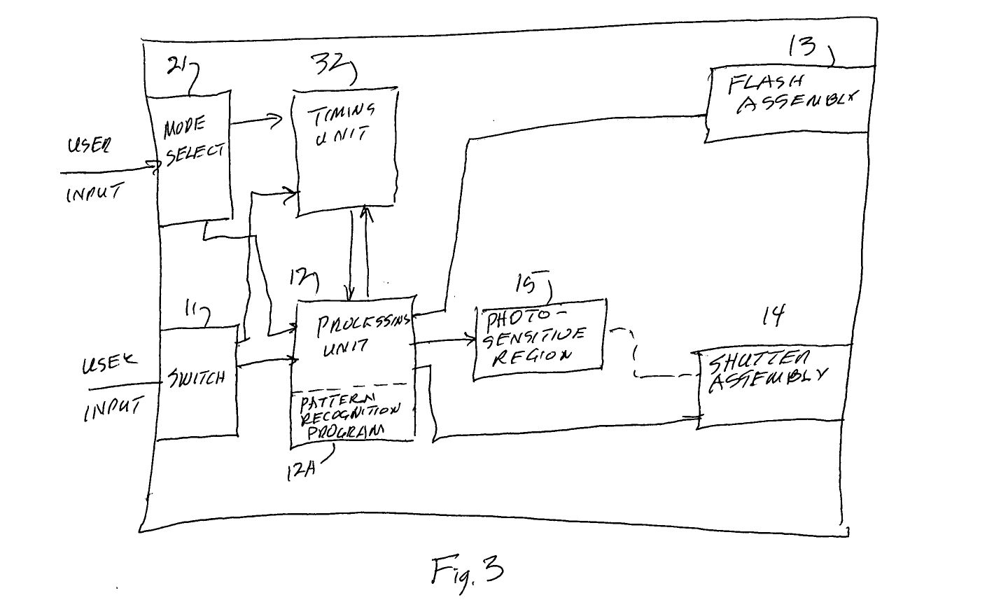

Referring to FIG. 3, a diagram of the components for implementation of a second embodiment of the present invention is shown. This embodiment includes a timing unit 32, as does the first embodiment. In addition, stored in memory portion 12A of the processing unit 12 is the pattern recognition program. Moreover, the use of the timing unit 32 is different than the use of the timing unit 22. When the alternative mode is selected by the mode switch 21, the activation of switch 11 results in the transfer of the pattern recognition program to the processing unit 12 and in a series of images being acquired on the photo-sensitive region 15. The activation of the alternative mode results in the processing by the pattern recognition program each image transferred to the processing unit 12. In this embodiment, each acquired image is processed to determine whether a predetermined feature, e.g., a smile on a face, is present. The identification of the predetermined feature results in a signal being applied to the timing unit 32 inactivating the unit. The image having the predetermined feature is then stored in the processing unit memory for further disposition by the user.

2. Operation of the Preferred Embodiment

The present invention permits the acquisition of an image having desired features. According to one embodiment, a false image acquisition cycle is used to permit the subjects to relax and provide a more natural image. A real image is then acquired by the camera. Such a stratagem is most clearly directed toward children but can also be of use in boisterous situations. In the second embodiment, a series of images are acquired, but all the images are analyzed to detect the presence of a predetermined feature. When that feature is identified, then the process is halted and the image having the predetermined feature is stored.

As will be clear, care must be taken that when the flash unit is activated for an actual exposure that the unit is fully discharged. In the first embodiment of the invention, the simulated exposure can be accompanied by a partial discharge of the flash unit, thereby permitting a more rapid recovery period. In the second embodiment, a somewhat more complicated strategy for the flash assembly can be used because of the sequence of exposures. A pattern recognition of the predetermined feature of the image can be possible without a flash or with reduced flash intensity. Thus, having identified the predetermined feature, the time to recharge the flash assembly for optimum image acquisition can be minimized.

In order to explain the operation of the present invention, the timing unit has been shown as a separate element. In practice, timing apparatus within the processing unit 12 can be used.

With respect to the implementation of a pattern recognition program, the digital signal processors currently included in digital cameras have the processing and storage capability to implement pattern recognition programs.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

1. A digital camera comprising;
a photosensitive region for recording an a optical image;
a controllable shutter for exposing the photosensitive region; and
a timer, the timer providing a selected time delay between a first shutter activation and a second shutter activation, the photosensitive region not recording an optical image during the first shutter activation.

2. The digital camera as recited in claim 1 wherein the first activation of the shutter is accompanied by sounds of typical shutter operation.

3. The digital camera as recited in claim 1 further comprising a flash mechanism, the flash mechanism receiving a low-power activation during the initial shutter activation.

4. The digital camera as recited in claim 1 wherein the first shutter activation is a simulation of signal acquisition.

5. A digital camera comprising:
a photosensitive area for recording an optical image projected thereon;
a shutter for exposing the photosensitive area;
a timer for periodically activating the shutter after an initial shutter activation; and
a processing unit, the processing unit analyzing the images recorded on the photo-sensitive area, the processing unit storing a pattern recognition program for identifying predetermined condition, the processing unit processing the images recorded on the photo-sensitive surface, the processing unit storing an image having predetermined conditions.

6. The digital signal processor as recited in claim 5 wherein the predetermined condition is a facial expression.

7. The digital signal processor as recited in claim 5 wherein the digital camera discontinues operation after acquisition of an image having the predetermined condition.

8. The method of acquiring an image with a digital camera having predetermined features, the method comprising:
simulating the acquisition of an image by the digital camera; and
after a preselected period of time, acquiring an image with the digital camera.

9. The method as recited in claim 8 wherein simulating the acquisition of an image includes providing the sights and sounds associated with the acquisition of an image.

10. The method of acquiring an image having predetermined features in a digital camera, the method comprising:
providing a program associated with a processing unit for identifying the predetermined features;
acquiring a series of images and applying the images to the processing unit; and
analyzing the images using the program.

11. The method as recited in claim 10 wherein the first image in which the predetermined feature is identified is stored.

12. The method as recited in claim 10 wherein the acquiring of a series images is provided in response to signals from a timing unit.

13. A digital camera comprising:
a first mode of operation, the digital camera in the first mode of operation acquiring an image in response to user input; and
a second mode of operation, the digital camera simulating acquiring an image in response to user input in the second mode of operation, the digital camera acquiring an image a preselected time after the simulating acquiring an image.

14. A digital camera comprising:
a first mode of operation, the digital camera acquiring an image in response to user input in the first mode of operation; and
a second mode of operation, the digital camera selecting for acquisition an image having predetermined features.

15. The digital camera as recited in claim 14 wherein the predetermined features are determined by a pattern recognition program.

16. The digital camera as recited in claim 14 wherein the predetermined features are facial expression.
